(19) United States
(12) Patent Application Publication
(10) Pub. No.: US 2009/0158307 A1
(43) Pub. Date: Jun. 18, 2009

(54) CONTENT PROCESSING APPARATUS, CONTENT PROCESSING METHOD, PROGRAM, AND RECORDING MEDIUM

(76) Inventor: Tatsuki KASHITANI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/329,782

(22) Filed: Dec. 8, 2008

(30) Foreign Application Priority Data
Dec. 14, 2007 (JP) P2007-322866

(51) Int. Cl. H04H 60/33; H04N 7/025

(52) U.S. Cl. 725/9; 725/32

(57) ABSTRACT

A content processing apparatus includes: a commercial specification unit for specifying types of commercials included in content viewed by a user; a commercial preference information generation unit for generating commercial preference information by associating each of the types of commercials with the number of times commercials of a corresponding one of the types have been viewed by the user in a predetermined period; a similarity computation unit for generating program commercial information of each recorded content by associating each of types of commercials inserted in the recorded content with the number of commercials of a corresponding one of the types, and computing a similarity between the program commercial information and the commercial preference information; and a recommendation specification unit for specifying content corresponding to the program commercial information having the computed similarity equal to or larger than a predetermined threshold value as content to be recommended for the user.

### CROSS REFERENCES TO RELATED APPLICATIONS

The present invention contains subject matter related to Japanese Patent Application JP 2007-322866 filed in the Japanese Patent Office on Dec. 14, 2007, the entire contents of which are incorporated herein by reference.

### BACKGROUND OF THE INVENTION

1. Field of the Invention

The present invention relates to content processing apparatuses, content processing methods, programs, and recording media, and, more particularly, to a content processing apparatus and a content processing method capable of making various recommendations that appropriately reflect viewer's preferences, a program, and a recording medium.

2. Description of the Related Art

With the proliferation of EPGs (Electronic Program Guide), an increasing number of HDD (Hard Disk Drive) recorders have a program retrieval function of allowing a user to specify a genre or keyword and retrieving a program using the specified genre or keyword.

A system having a function of recommending a program to be recorded on the basis of user's preference information has been proposed (see, for example, Japanese Unexamined Patent Application Publication No. 2003-114903).

According to a technique disclosed in Japanese Unexamined Patent Application Publication No. 2003-114903, a server receives from the terminal of each service user preference degree data that is an index of the program preference of the service user. The server computes the correlation of a program preference tendency between one service user and each of the other service users. On the basis of the computed preference correlations and reservation information, the server calculates predicted values of the preference degree of each user for programs to be broadcast. The terminal of each user refers to the calculated predicted values of the preference degree for programs to be broadcast so as to create a list of programs to be recommended to the service user.

In order to generate user's preference information, for example, metadata of a program included in an EPG is analyzed.

In recent HDD recorders, it is possible to specify commercials (CMs) provided with a program. There are no preference information generation methods in the related art which use commercial information.

In many cases, the same commercial is broadcast irrespective of date, time, program, and channel. Accordingly, commercial information can be considered to be useful for the comparison between programs performed in preference information generation.

It is desirable to provide a content processing apparatus and a content processing method capable of making various recommendations that appropriately reflect viewer's preferences.

### SUMMARY OF THE INVENTION

A content processing apparatus according to an embodiment of the present invention includes: commercial specifying means for specifying types of commercials included in content viewed by a user; commercial preference information generating means for generating commercial preference information by associating each of the types of commercials with the number of times commercials of a corresponding one of the types have been viewed by the user in a predetermined period; similarity computing means for generating program commercial information of each of a plurality of pieces of recorded content by associating each of types of commercials inserted in each of the plurality of pieces of recorded content with the number of commercials of a corresponding one of the types, and computing a similarity between the program commercial information and the commercial preference information; and recommendation specifying means for specifying content corresponding to the program commercial information having the computed similarity equal to or larger than a predetermined threshold value as content to be recommended for the user.

The content processing apparatus can further include viewing determining means for outputting information used to determine whether the user has actually viewed the commercials included in the content.

Each of the commercial preference information and the program commercial information can be generated as a vector in which each of the types of commercials is set as an element and a value obtained by normalizing the number of commercials of a corresponding one of the types in a predetermined format is used as a value of the element.

A content processing method according to an embodiment of the present invention includes the steps of: generating commercial preference information by associating each of types of commercials included in content viewed by a user with the number of times commercials of a corresponding one of the types have been viewed by the user in a predetermined period; generating program commercial information of each of a plurality of pieces of recorded content by associating each of types of commercials inserted in each of the plurality of pieces of recorded content with the number of commercials of a corresponding one of the types, and computing a similarity between the program commercial information and the commercial preference information; and specifying content corresponding to the program commercial information having the computed similarity equal to or larger than a predetermined threshold value as content to be recommended for the user.

A program according to an embodiment of the present invention causes a computer to function as: commercial specifying means for specifying types of commercials included in content viewed by a user; commercial preference information generating means for generating commercial preference information by associating each of the types of commercials with the number of times commercials of a corresponding one of the types have been viewed by the user in a predetermined period; similarity computing means for generating program commercial information of each of a plurality of pieces of recorded content by associating each of types of commercials inserted in each of the plurality of pieces of recorded content with the number of commercials of a corresponding one of the types, and computing a similarity between the program commercial information and the commercial preference information; and recommendation specifying means for specifying content corresponding to the program commercial information having the computed similarity equal to or larger than a predetermined threshold value as content to be recommended for the user.

According to an embodiment of the present invention, commercial preference information is generated by associating each of types of commercials included in content viewed by a user with the number of times commercials of a corresponding one of the types have been viewed by the user in a predetermined period. Program commercial information is generated by associating each of types of commercials inserted in each of a plurality of pieces of recorded content with the number of commercials of a corresponding one of the types. A similarity between the program commercial information and the commercial preference information is computed. Content corresponding to the program commercial information having the computed similarity equal to or larger than a predetermined threshold value is specified as content to be recommended for the user.

A content processing apparatus according to an embodiment of the present invention includes: commercial specifying means for specifying types of commercials included in content viewed by a user; commercial preference information generating means for generating commercial preference information by associating each of the types of commercials with the number of times commercials of a corresponding one of the types have been viewed by the user in a predetermined period; similarity computing means for computing a similarity between the commercial preference information and viewing characteristic information provided in advance; and recommendation specifying means for specifying information about a product corresponding to the viewing characteristic information having the computed similarity equal to or larger than a predetermined threshold value as information about a product to be recommended for the user.

The content processing apparatus can further include viewing determining means for outputting information used to determine whether the user has actually viewed the commercials included in the content.

The commercial preference information can be generated as a vector in which each of the types of commercials is set as an element and a value obtained by normalizing the number of commercials of a corresponding one of the types in a predetermined format is used as a value of the element. The viewing characteristic information can be generated as a vector including the same elements as those included in a vector serving as the commercial preference information.

The content processing apparatus can further include storing means for associating the information about a product with the viewing characteristic information and storing them. The viewing characteristic information supplied from a provider of the product can be associated with the product and then be stored.

A content processing method according to an embodiment of the present invention includes the steps of: generating commercial preference information by associating each of types of commercials included in content viewed by a user with the number of times commercials of a corresponding one of the types have been viewed by the user in a predetermined period; computing a similarity between the commercial preference information and viewing characteristic information provided in advance; and specifying information about a product corresponding to the viewing characteristic information having the computed similarity equal to or larger than a predetermined threshold value as information about a product to be recommended for the user.

A program according to an embodiment of the present invention causes a computer to function as: commercial specifying means for specifying types of commercials included in content viewed by a user; commercial preference information generating means for generating commercial preference information by associating each of the types of commercials with the number of times commercials of a corresponding one of the types have been viewed by the user in a predetermined period; similarity computing means for computing a similarity between the commercial preference information and viewing characteristic information provided in advance; and recommendation specifying means for specifying information about a product corresponding to the viewing characteristic information having the computed similarity equal to or larger than a predetermined threshold value as information about a product to be recommended for the user.

According to an embodiment of the present invention, commercial preference information is generated by associating each of types of commercials included in content viewed by a user with the number of times commercials of a corresponding one of the types have been viewed by the user in a predetermined period. A similarity between the commercial preference information and viewing characteristic information provided in advance is computed. Information about a product corresponding to the viewing characteristic information having the computed similarity equal to or larger than a predetermined threshold value is specified as information about a product to be recommended for the user.

According to an embodiment of the present invention, there can be provided a content processing apparatus and a content processing method capable of making various recommendations that appropriately reflect viewer's preferences.

### BRIEF DESCRIPTION OF THE DRAWINGS

FIG. 1 is a block diagram illustrating an exemplary configuration of a recommendation system according to an embodiment of the present invention;

FIG. 2 is a diagram illustrating an example of a viewing history;

FIG. 3 is a diagram describing program recommendation;

FIG. 4 is a diagram describing product recommendation;

FIG. 5 is a diagram describing similar program retrieval;

FIG. 6 is a diagram illustrating an example of program scheduling information;

FIG. 7 is a flowchart describing a program recommendation process;

FIG. 8 is a flowchart describing a product recommendation process; and

FIG. 9 is a block diagram illustrating an exemplary configuration of a personal computer.

### DESCRIPTION OF THE PREFERRED EMBODIMENTS

Before describing embodiments of the present invention, the correspondence between the features of the present invention and embodiments of the present invention disclosed in this specification or the accompanying drawings is discussed below. This description is intended to assure that embodiments supporting the present invention are described in this'specification or the accompanying drawings. Thus, even if an embodiment in this specification or the accompanying drawings is not described as relating to a certain feature of the present invention, that does not necessarily mean that the embodiment does not relate to that feature of the present invention. Conversely, even if an embodiment is described herein as relating to a certain feature of the present invention, that does not necessarily mean that the embodiment does not relate to other features of the present invention.

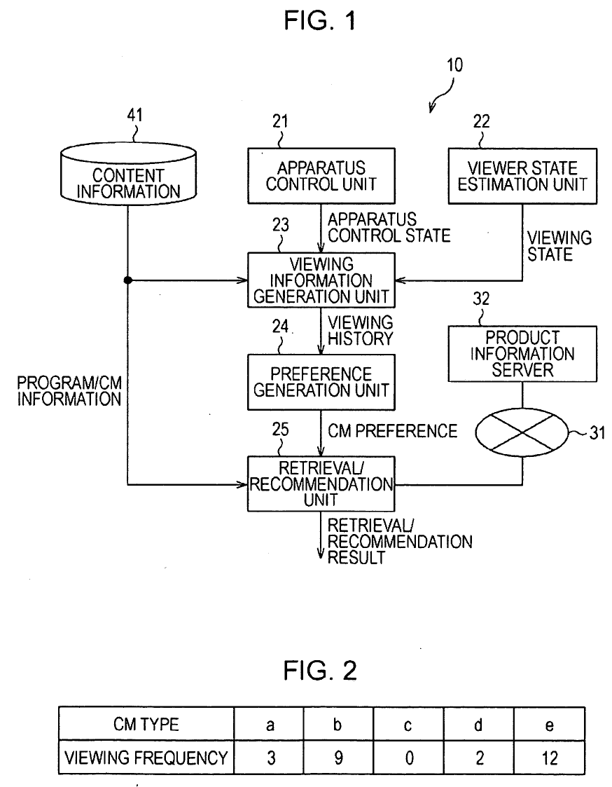

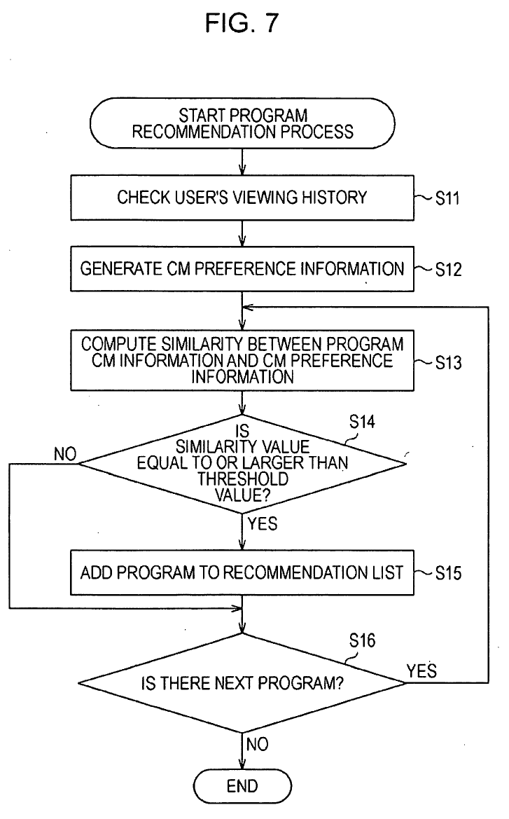

A content processing apparatus according to an embodiment of the present invention includes: commercial specifying means (for example, a viewing information generation unit 23 illustrated in FIG. 1) for specifying types of commercials included in content viewed by a user; commercial preference information generating means (for example, a preference generation unit 24 illustrated in FIG. 1) for generating commercial preference information by associating each of the types of commercials with the number of times commercials of a corresponding one of the types have been viewed by the user in a predetermined period; similarity computing means (for example, a retrieval/recommendation unit 25 illustrated in FIG. 1 which performs processing in step S13 illustrated in FIG. 7) for generating program commercial information of each of a plurality of pieces of recorded content by associating each of types of commercials inserted in each of the plurality of pieces of recorded content with the number of commercials of a corresponding one of the types, and computing a similarity between the program commercial information and the commercial preference information; and recommendation specifying means (for example, the retrieval/recommendation unit 25 illustrated in FIG. 1 which performs processing n step S15 illustrated in FIG. 7) for specifying content corresponding to the program commercial information having the computed similarity equal to or larger than a predetermined threshold value as content to be recommended for the user.

The content processing apparatus can further include viewing determining means (for example, a viewer state estimation unit 22 illustrated in FIG. 1) for outputting information used to determine whether the user has actually viewed the commercials included in the content.

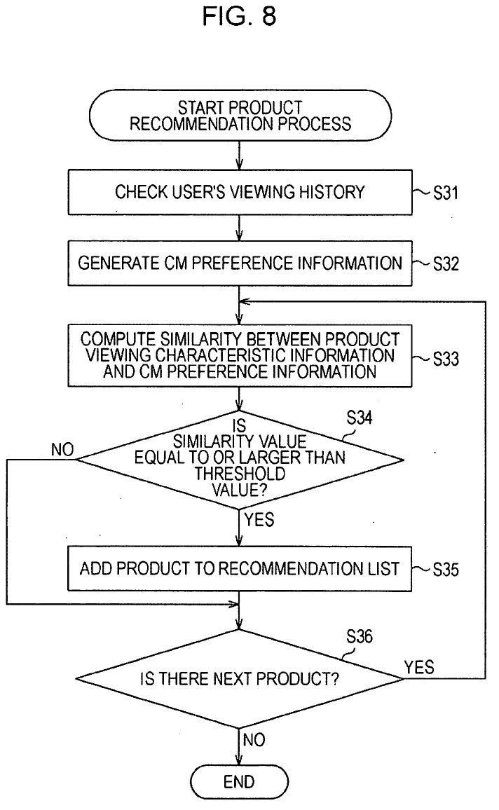

A content processing apparatus according to an embodiment of the present invention includes: commercial specifying means (for example, the viewing information generation unit 23 illustrated in FIG. 1) for specifying types of commercials included in content viewed by a user; commercial preference information generating means (for example, the preference generation unit 24 illustrated in FIG. 1) for generating commercial preference information by associating each of the types of commercials with the number of times commercials of a corresponding one of the types have been viewed by the user in a predetermined period; similarity computing means (for example, the retrieval/recommendation unit 25 illustrated in FIG. 1 which performs processing in step S33 illustrated in FIG. 8) for computing a similarity between the commercial preference information and viewing characteristic information provided in advance; and recommendation specifying means (for example, the retrieval/recommendation unit 25 illustrated in FIG. 1 which performs processing in step S35 illustrated in FIG. 8) for specifying information about a product corresponding to the viewing characteristic information having the computed similarity equal to or larger than a predetermined threshold value as information about a product to be recommended for the user.

Embodiments of the present invention will be described below with reference to the accompanying drawings.

FIG. 1 is a block diagram illustrating an exemplary configuration of a recommendation system according to an embodiment of the present invention. A recommendation system 10 is embedded in, for example, an HDD (Hard Disk Drive) recorder, and is configured to analyze commercials (hereinafter referred to as commercials) inserted in a television program viewed by a user, specify a program or product that suits user's preferences, and generate information about a recommended program or product.

An apparatus control unit 21 operates in synchronization with a control unit included in the HDD recorder in which the recommendation system 10 is embedded, and is configured to output information used to specify content (for example, a program) being reproduced that is one of pieces of content recorded in the HDD recorder as apparatus control state information.

The viewer state estimation unit 22 is configured to detect whether a person (user) is present within a predetermined area around the HDD recorder or a television receiver to which the HDD recorder is connected using an infrared sensor, a microwave sensor, a camera, or a microphone and output the detection result as viewing state information used to estimate whether a user has actually viewed reproduced content.

The viewing information generation unit 23 specifies, on the basis of information stored in a content information database 41, a commercial included in content specified on the basis of the apparatus control state information. The content information database 41 associates information specifying a broadcast program with information about the type of a commercial broadcast with the program and information about the number of times the commercial has been broadcast in the program and stores them. That is, the viewing information generation unit 23 specifies the type of a commercial broadcast with reproduced content (program) and the number of times the commercial has been broadcast in the program.

The viewing information generation unit 23 estimates whether a user has viewed reproduced content on the basis of the viewing state information. If the viewing information generation unit 23 estimates that the user has viewed the reproduced content, it associates the type of a commercial broadcast with the reproduced content (program) with the number of times the commercial has been broadcast and stores them as a viewing history of the user.

The viewing history is stored in a predetermined area in an HDD included in the HDD recorder as, for example, information illustrated in FIG. 2.

Referring to FIG. 2, in a commercial type field, “a”, “b”, “c”, “d”, and “e” are illustrated as pieces of information representing commercial genres such as “health”, “entertainment” and “finance”. For example, a health food commercial is categorized as a commercial belonging to the genre “health”, a television receiver commercial is categorized as a commercial belonging to the genre “entertainment”, and an insurance commercial is categorized as a commercial belonging to the genre “finance”.

Alternatively, “a”, “b”, “c”, “d”, and “e” may be illustrated as pieces of information representing commercial sponsors (advertisers such as manufacturers) or commercial products (alcohol, car, game machine, etc.).

In an example illustrated in FIG. 2, the number of times a user has viewed each type (“a”, “b”, “c”, “d”, or “e”) of commercial is illustrated. That is, if it is estimated that a user has viewed reproduced content, commercials broadcast with the content (program) are categorized into the commercial types “a”, “b”, “c”, “d”, and “e” and it is determined how many times each type of commercial has been broadcast. The determination result is stored in the viewing history.

The viewing history illustrated in FIG. 2 may be generated for each piece of reproduced content or pieces of content reproduced in a predetermined period (for example, one month). It is needless to say that the viewing history may be generated for pieces of content reproduced in a period between a viewing history generation time and a current time.

The preference generation unit 24 generates commercial preference information on the basis of the viewing history generated by the viewing information generation unit 23. The commercial preference information is, for example, information obtained by normalizing the viewing history illustrated in FIG. 2 in a predetermined format.

For example, in the case of the example illustrated in FIG. 2, a vector obtained by dividing the value of the broadcast frequency corresponding to each of the commercial types “a”, “b”, “c”, “d”, and “e” by the sum total of values described in the broadcast frequency field is set as the commercial preference information. That is, since the sum total of broadcast frequency values is 26 (=3+9+0+2+12), a vector Vc set as the commercial preference information is calculated as follows.

Vc=(3/26, 9/26, 0, 2/26, 12/26)

The retrieval/recommendation unit 25 specifies commercials included in content (program) recorded in the HDD recorder on the basis of information stored in the content information database 41, categorizes the commercials into the commercial type “a”, “b”, “c”, “d”, and “e”, determines how many times each type of commercial has been broadcast in the program, and associates each type of commercial with the number of times commercials of the type have been broadcast. Furthermore, the retrieval/recommendation unit 25 generates a vector by dividing the value of the broadcast frequency of each type (“a”, “b”, “c”, “d”, or “e”) of commercial by the sum total of the values of broadcast frequency of all commercials broadcast in the program and sets the generated vector as program commercial information. As a result, as in the case of the commercial preference information, a five-dimensional vector is generated as the program commercial information.

As the program commercial information and the commercial preference information, a five-dimensional vector is used. However, another information may be used.

The retrieval/recommendation unit 25 computes the similarity between the program commercial information of each of pieces of content recorded in the HDD recorder and the commercial preference information generated by the preference generation unit 24, and determines whether the similarity is equal to or larger than a predetermined threshold value. If the similarity is equal to or larger than the threshold value, the retrieval/recommendation unit 25 outputs information specifying content corresponding to the program commercial information having the similarity as information about a recommended program.

Furthermore, the retrieval/recommendation unit 25 is configured to acquire product information stored in a product information server 32 connected thereto via a network 31 such as the Internet.

The product information server 32 stores a plurality of pieces of data such as advertisement images (or sound) of products supplied from sponsors such as product providing companies. Furthermore, the product information server 32 stores viewing characteristic information associated with each of the products.

The viewing characteristic information is, for example, commercial preference information defined by a sponsor, and represents the preference of a person assumed to be a buyer of a predetermined product. As the viewing characteristic information, a vector similar to the vector used as the commercial preference information is used.

The retrieval/recommendation unit 25 computes the similarity between the viewing characteristic information of each of the products recorded in the product information server 32 and the commercial preference information generated by the preference generation unit 24, and determines whether the similarity is equal to or larger than a predetermined threshold value. If the similarity is equal to or larger than the threshold value, the retrieval/recommendation unit 25 outputs information specifying a product corresponding to the viewing characteristic information having the similarity as information about a recommended product.

Furthermore, the retrieval/recommendation unit 25 is configured to retrieve content similar to content specified by a user from among pieces of content recorded in the HDD recorder. In this case, the retrieval/recommendation unit 25 computes the similarity between the program commercial information of the content specified by the user and the program commercial information of each of the pieces of content recorded in the HDD recorder, and determines whether the similarity is equal to or larger than a predetermined threshold value. If the similarity is equal to or larger than the threshold value, the retrieval/recommendation unit 25 outputs information specifying content corresponding to the program commercial information having the similarity.

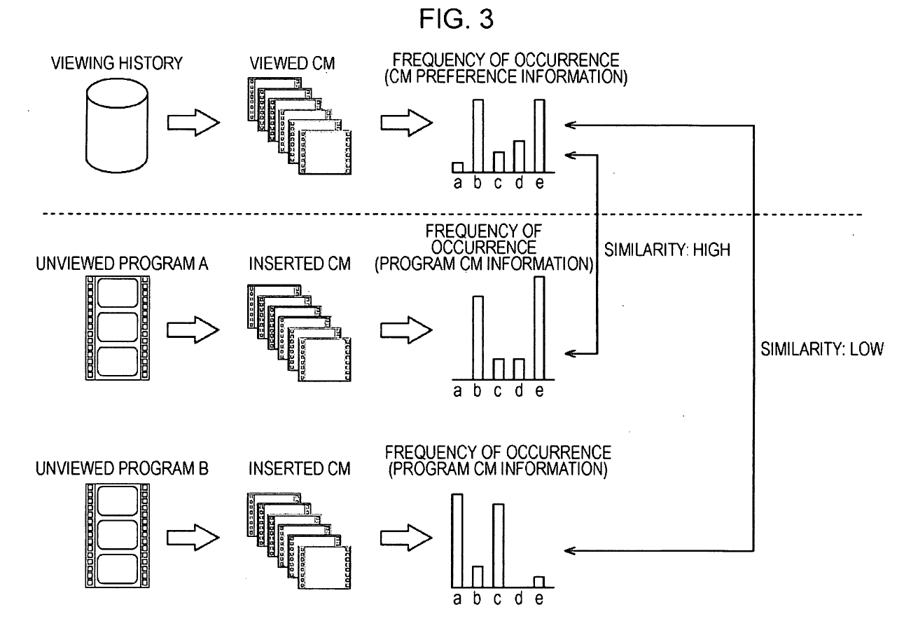

Further description will be made with reference to FIGS. 3 to 5.

FIG. 3 is a diagram describing an exemplary case in which the recommendation system 10 recommends content. If the recommendation system 10 recommends content, it specifies the types of commercials viewed by a user on the basis of the viewing history, and normalizes the number of times commercials of each of the types have been viewed so as to generate the commercial preference information. Referring to FIG. 3, the types of commercials viewed by a user are specified on the basis of the viewing history and the number of times commercials of each of the types (“a”, “b”, “c”, “d”, and “e”) have been viewed is normalized, whereby a bar chart representing the frequency of occurrence is displayed.

The recommendation system 10 specifies the types of commercials broadcast with an unviewed program which is recorded in the HDD recorder and has yet to be viewed by a user (commercials inserted in an unviewed program) and normalizes the number of times commercials of each of the types have been broadcast so as to generate the program commercial information. Referring to FIG. 3, the number of times each type of content included in each of an unviewed program A and an unviewed program B has been broadcast is normalized, whereby a bar chart representing the frequency of occurrence is displayed.

The recommendation system 10 computes the similarity between the frequency of occurrence obtained from the viewing history and the frequency of occurrence of the unviewed program A or the unviewed program B, and specifies content to be recommended in accordance with the degree of the similarity. In this example, the similarity between the frequency of occurrence obtained from the viewing history and the frequency of occurrence of the unviewed program A is high, and the similarity between the frequency of occurrence obtained from the viewing history and the frequency of occurrence of the unviewed program B is low.

In reality, the similarity is computed by calculating the inner product of the vector generated as the commercial preference information and the vector generated as the program commercial information.

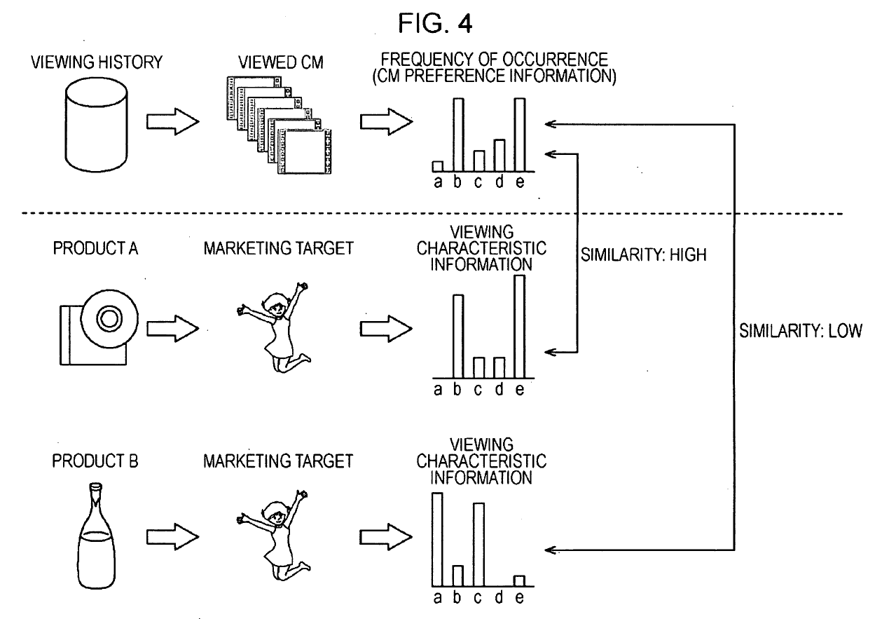

FIG. 4 is a diagram describing an exemplary case in which the recommendation system 10 recommends a product. If the recommendation system 10 recommends a product, it specifies the types of commercials viewed by a user on the basis of the viewing history and normalizes the number of times commercials of each of the types have been viewed so as to generate the commercial preference information. Referring to FIG. 4, the types of commercials viewed by a user are specified on the basis of the viewing history and the number of times each type (“a”, “b”, “c”, “d”, or “e”) of commercial has been viewed is normalized, whereby a bar chart representing the frequency of occurrence is displayed.

For example, the recommendation system 10 acquires the viewing characteristic information stored/recorded in the product information server. As described previously, the viewing characteristic information is similarly obtained by normalizing the number.of times each type (“a”, “b”, “c”, “d”, or “e”) of commercial has been viewed. Referring to FIG. 4, as in the case of the frequency of occurrence, the viewing characteristic information of each of products A and B is displayed as a bar chart.

The recommendation system 10 computes the similarity between the frequency of occurrence obtained from the viewing history and the frequency of occurrence of the product A or B, and specifies a product to be recommended in accordance with the degree of the similarity. In this example, the similarity between the frequency of occurrence obtained from the viewing history and the frequency of occurrence of the product A is high, and the similarity between the frequency of occurrence obtained from the viewing history and the frequency of occurrence of the product B is low.

In reality, the similarity is computed by calculating the inner product of the vector generated as the commercial preference information and the vector generated as the viewing characteristic information. As described previously, as in the case of the commercial preference information, as the viewing characteristic information, a vector (in this case, a five-dimensional vector) is used.

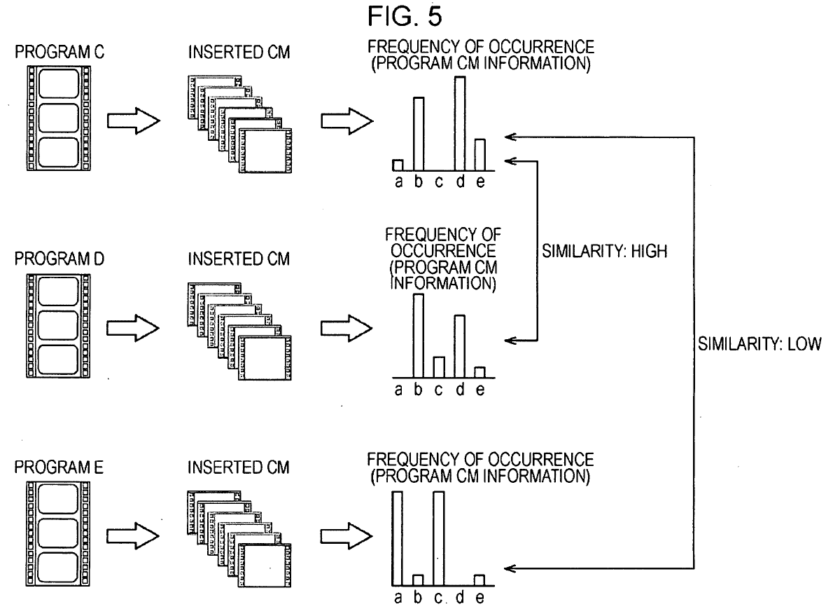

FIG. 5 is a diagram describing an exemplary case in which the recommendation system 10 retrieves similar content. If the recommendation system 10 retrieves similar content, for example, it specifies the types of commercials broadcast with a program C that is content specified by a user (commercials inserted in the program C) and normalizes the number of times each type of commercial has been broadcast so as to generate the commercial program information. Referring to FIG. 5, the types of commercials inserted in the program C are specified and the number of times each type (“a”, “b”, “c”, “d”, or “e”) of commercial has been broadcast is normalized, whereby a bar chart representing the frequency of occurrence is displayed.

The recommendation system 10 specifies the types of commercials inserted in each of programs D and E which are pieces of content recorded in the HDD recorder and normalizes the number of times each type of commercial has been broadcast so as to generate the program commercial information. Referring to FIG. 5, the number of times each type of commercial included in each of the programs D and E is normalized, whereby a bar chart representing the frequency of occurrence is displayed.

The recommendation system 10 computes the similarity between the frequency of occurrence obtained from the program C and the frequency of occurrence obtained from the program D or E, and specifies a program (content) similar to the program C in accordance with the degree of the similarity. In this example, the similarity between the frequency of occurrence obtained from the program C and the frequency of occurrence obtained from the program D is high, and the similarity between the frequency of occurrence obtained from the program C and the frequency of occurrence obtained from the program E is low.

In reality, the similarity is computed by calculating the inner product of the vectors generated as the pieces of program commercial information.

As describer previously, the content information database 41 associates information specifying a broadcast program with information about the type of a commercial broadcast with the program and information about the number of times the commercial has been broadcast in the program and stores them. Information to be stored in the content information database 41 is distributed via television broadcasting, cable television broadcasting, or the Internet.

For example, as information to be stored in the content information database 41, information supplied from a company that provides metadata of a broadcast program can be used.

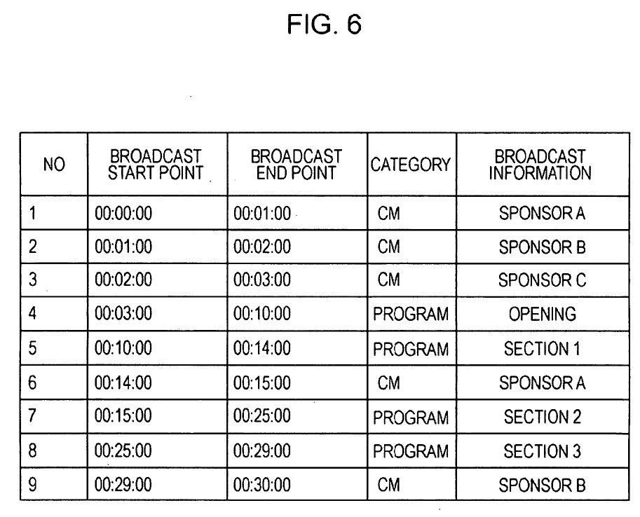

For example, information illustrated in FIG. 6 is supplied from a broadcast station or a company that provides metadata of a broadcast program. FIG. 6 illustrates an example of program scheduling information of a certain program. In this example of program scheduling information, a half-hour program is divided into segments “No. 1” to “No. 9”. The segments “No. 1”, “No. 2”, “No. 3”, “No. 6, and “No. 9” are commercial segments. Information specifying a sponsor (sponsor A, B, or C) of each commercial is displayed as broadcast information.

The above-described information of the program is associated with information about a channel on which the program has been broadcast, broadcast start time information, and broadcast end time information, and is supplied as illustrated in FIG. 6.

For example, if a user specifies a commercial part of reproduced content on the basis of the broadcast start point and the broadcast end point illustrated in FIG. 6 and specifies the type of each commercial on the basis of the information about a commercial sponsor illustrated in FIG. 6, the viewing history described previously with reference to FIG. 2 can be generated.

If information specifying a commercial is included in metadata added to a program broadcast in digital broadcasting, information to be stored in the content information database 41 may be generated on the basis of the metadata.

More specifically, for example, in terrestrial digital broadcasting or digital broadcasting such as one-segment broadcasting (so-called 1 seg), a method of transmitting data along with a video signal and an audio signal is standardized for each broadcast station. Data broadcasting that transmits EPG information and data linked/supplementary to information on a program is performed. Using such data broadcasting, an advanced EPG (Electronic Program Guide) including commercial information can be broadcast. For example, information to be stored in the content information database 41 may be generated using an advanced EPG delivered in data broadcasting.

An exemplary case has been described in which the program commercial information of content recorded in the HDD recorder is generated and a recommended program is specified using the program commercial information. However, if the above-described program scheduling information or the above-described advanced EPG including commercial information is provided or broadcast prior to broadcasting of a program, it is possible to generate the program commercial information of the program to be broadcast and specify a recommended program using the generated program commercial information.

Alternatively, information to be stored in the content information database 41 may be generated in the following manner. Video data or audio data included in content recorded in the HDD recorder is analyzed so as to detect a commercial. In order to specify the detected commercial, character recognition is performed by analyzing a telop included in a commercial image or speech recognition is performed. On the basis of the specification result, information to be generated in the content information database 41 is generated.

Next, a program recommendation process performed by the recommendation system 10 according to an embodiment of the present invention will be described with reference to a flowchart illustrated in FIG. 7.

In step S11, the preference generation unit 24 checks a viewing history generated by the viewing information generation unit 23.

At that time, for example, a storage period may be set for the viewing history. As described previously, the viewing history may be generated for each piece of reproduced content, pieces of content reproduced in a predetermined period (for example, one month), or pieces of content reproduced in a period between a viewing history generation time and a current time. For example, processing for specifying any one of a viewing history generated for the last reproduced piece of content, a viewing history generated for pieces of content reproduced in the past one month, or a viewing history generated for pieces of content reproduced in a period between a viewing history generation time and a current time may be performed.

In step S12, the preference generation unit 24 generates commercial preference information on the basis of the viewing history checked in step S1.

In step S13, the retrieval/recommendation unit 25 specifies commercials included in content recorded in the HDD recorder on the basis of information stored in the content information database 41. The retrieval/recommendation unit 25 specifies the types of the commercials broadcast with the content (program), determines how many times each type of commercial has been broadcast in the program, and associates each of the types of the commercials with the number of times commercials of the type have been broadcast in the program so as to generate information. The retrieval/recommendation unit 25 normalizes the generated information so as to generate program commercial information. The retrieval/recommendation unit 25 computes the similarity between the generated program commercial information and the commercial preference information generated in step S12. For example, the similarity is computed by calculating the inner product of a vector generated as the commercial preference information and a vector generated as the program commercial information.

In step S14, the retrieval/recommendation unit 25 determines whether the similarity computed in step S13 is equal to or larger than a threshold value set in advance. If it is determined that the similarity is equal to or larger than the threshold value, the process proceeds to step S15. If it is determined that the similarity is smaller than the threshold value, the processing in step S15 is skipped.

In step S15, the retrieval/recommendation unit 25 adds the program (the content having the similarity computed in step S13 which is equal to or larger than the threshold value) to a recommendation list.

In step S16, the retrieval/recommendation unit 25 determines whether there is a next piece of content recorded in the HDD recorder. If it is determined that there is a next piece of content, the process returns to step S13. Subsequently, the process from step S13 to step S16 is repeated.

If it is determined in step S16 that there is no content, the process ends. At that time, for example, pieces of content included in the recommendation list may be displayed on a screen of a television receiver connected to the HDD recorder. Alternatively, a recommended program mark may be put on some of the pieces of content recorded in the HDD recorder which are included in the recommendation list, and these pieces of content may be displayed on the screen of the television receiver.

In the above-described process, in step S13, the program commercial information is generated for each piece of content recorded in the HDD recorder, and the similarity between the generated program commercial information and the commercial preference information generated in step S12 is computed. However, for example, if another preference information is obtained on the basis of information other than the commercial viewing history, the similarity may be computed as follows. On the basis of another preference information, a plurality of pieces of content to be recommended are selected from among the pieces of content recorded in the HDD recorder in advance. In step S13, the program commercial information is generated for each of the pieces of content that have been selected as pieces of content to be recommended. The similarity between the generated program commercial information and the commercial preference information generated in step S12 is computed.

That is, for example, on the basis of the commercial viewing history, it is possible to narrow down programs recommended on the basis of preference information generated using a method in the related art.

Thus, content (program) is recommended.

The generation of preference information has been performed on the basis of the history of recorded programs and recommendation has been performed on the basis of the preference information. However, in this case, a program similar in content (for example, genre) to recorded programs is usually recommended.

In the present invention, program recommendation is performed on the basis of the commercial viewing history. The sponsor of a program pays a commercial advertising rate, and a commercial is broadcast as an advertisement for viewers of the program. The sponsor who pays a commercial advertising rate hopes that a commercial is to be viewed by viewers who are interested in the product of the sponsor. Accordingly, for example, few sponsors pay an advertising rate so as to insert an alcohol commercial in a program for children. That is, a commercial is usually broadcast for viewers who are assumed to be fond of viewing a program in which the commercial is inserted. Therefore, a program is usually produced so as to meet sponsor's expectations and gain viewers assumed to be fond of viewing the program.

The above-described assumed viewers are specified in accordance with not only information about viewer's characteristics such as age and gender but also more detailed characteristic information, for example, “a single female who is aged between 20 and 29 and is working in a metropolitan area and whose hobby is playing tennis”.

That is, by analyzing commercials inserted in a program, target viewers for the program or viewers assumed by the producer of the program can be classified. According to an embodiment of the present invention, program recommendation is performed on the basis of a commercial viewing history. Accordingly, in contrast to program recommendation performed on the basis of preference information in the related art, it is possible to perform program recommendation irrespective of the contents of recorded programs and to recommend a program conforming to a user's preference.

By narrowing down programs recommended on the basis of preference information in the related art using a commercial viewing history, it is possible to recommend a program more suitable for the user.

A product recommendation process preformed by the recommendation system 10 according to an embodiment of the present invention will be described with reference to FIG. 8.

The processing operations in steps S31 and S32 are the same as those in steps S11 and S12 illustrated in FIG. 7, and the description thereof will be therefore omitted.

In step S33, the retrieval/recommendation unit 25 acquires product information stored in the product information server 32 connected thereto via the network 31 such as the Internet so as to acquire viewing characteristic information associated with each product. The retrieval/recommendation unit 25 computes the similarity between the viewing characteristic information acquired from the product information server 32 and the commercial preference information generated in step 332. For example, the similarity is computed by calculating the inner product of a vector generated as the commercial preference information and a vector generated as the viewing characteristic information.

In step S34, the retrieval/recommendation unit 25 determines whether the similarity computed in step S33 is equal to or larger than a threshold value set in advance. If it is determined that the similarity is equal to or larger than the threshold value, the process proceeds to step S35. If it is determined that the similarity is smaller than the threshold value, the processing in step S35 is skipped.

In step S35, the retrieval/recommendation unit 25 adds the product (the product having the similarity computed in step S33 which is equal to or larger than the threshold value) to a recommendation list.

In step S36, the retrieval/recommendation unit 25 determines whether there is a next product stored in the product information server 32. If it is determined that there is a next product, the process returns to step S33. Subsequently, the process from step S33 to step S36 is repeated.

If it is determined in step S36 that there is no product, the process ends. At that time, for example, products included in the recommendation list are displayed on a screen of a television receiver connected to the HDD recorder.

Thus, a product is recommended.

As described previously, by analyzing commercials inserted in a program, target viewers for the program or viewers assumed by the producer of the program can be classified. According to an embodiment of the present invention, program recommendation is performed on the basis of a commercial viewing history. Accordingly, in contrast to program recommendation performed on the basis of preference information in the related art, it is possible to perform product recommendation irrespective of the contents of recorded programs and previously purchased products and to recommend a product conforming to a user's preference.

As described previously, for example, the viewing characteristic information is the commercial preference information defined by a sponsor (product providing company). Accordingly, it is possible to recommend a product suitable for a person assumed by a sponsor to be a buyer of a predetermined product.

In a product recommendation method in the related art, for example, it is sometimes necessary for a user to disclose personal information such as age and gender. In the present invention, however, it is possible to recommend a product conforming to a user's preference without requesting a user to disclose personal information.

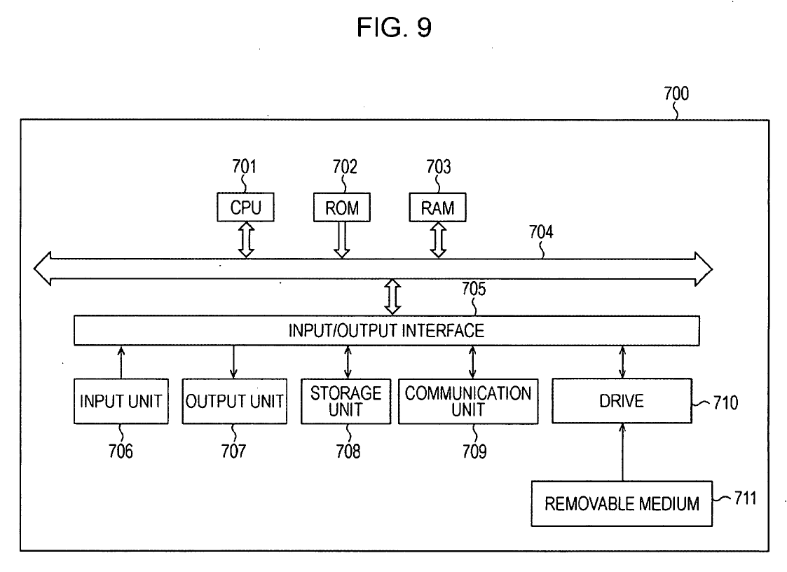

The above-described series of processes may be performed by hardware or software. If the series of processes are performed by software, a program configuring the software is installed from a network or a recording medium on a computer embedded in a piece of dedicated hardware or, for example, on a general-purpose personal computer 700 illustrated in FIG. 9 which is allowed to perform various functions by installing various programs thereon.

Referring to FIG. 9, a CPU (Central Processing Unit) 701 performs various types of processing in accordance with a program stored in a ROM (Read-Only Memory) 702 or a program loaded from a storage unit 708 to a RAM (Random Access Memory) 703. Data necessary for various types of processing to be performed by the CPU 701 is also stored in the RAM 703 as appropriate.

The CPU 701, the ROM 702, and the RAM 703 are connected to each other via a bus 704. An input/output interface 705 is connected to the bus 704.

An input unit 706 including a keyboard and a mouse, an output unit 707 including a display such as a CRT (Cathode-Ray Tube) or an LCD (Liquid Crystal display) and a speaker, the storage unit 708 including a hard disk, and a communication unit 709 including a modem and a network interface such as a LAN card are connected to the input/output interface 705. The communication unit 709 performs communication processing via a network including the Internet.

A drive 710 is connected to the input/output interface 705 when necessary. A removable medium 711 such as a magnetic disk, an optical disc, a magneto-optical disk, or a semiconductor memory is installed in the drive 710 as appropriate. A computer program read from the removable medium 711 is installed into the storage unit 708 when necessary.

If the series of processes are performed by software, a program configuring the software is installed from a network such as the Internet or a recording medium such as the removable medium 711.

The recording medium not only includes the removable medium 711 illustrated in FIG. 9 such as a magnetic disk (including a floppy disk (registered trademark)), an optical disc (including a CD-ROM (Compact Disc-Read-Only Memory) and a DVD (Digital Versatile Disk)), a magneto-optical disk (including an MD (Mini-Disk) (registered trademark)), or a semiconductor memory, which records a program and is distributed so as to provide the program for a user separately from the apparatus, but also includes the ROM 702 and the hard disk included in the storage unit 708, which record a program and are built in the apparatus to be provided for the user.

In this specification, steps performing the above-described series of processes are not necessarily performed in chronological order described above. The steps may be concurrently or individually.

It should be understood by those skilled in the art that various modifications, combinations, sub-combinations and alterations may occur depending on design requirements and other factors insofar as they are within the scope of the appended claims or the equivalents thereof.

What is claimed is:

1. A content processing apparatus comprising:
commercial specifying means for specifying types of commercials included in content viewed by a user;
commercial preference information generating means for generating commercial preference information by associating each of the types of commercials with the number of times commercials of a corresponding one of the types have been viewed by the user in a predetermined period;
similarity computing means for generating program commercial information of each of a plurality of pieces of recorded content by associating each of types of commercials inserted in each of the plurality of pieces of recorded content with the number of commercials of a corresponding one of the types, and computing a similarity between the program commercial information and the commercial preference information; and
recommendation specifying means for specifying content corresponding to the program commercial information having the computed similarity equal to or larger than a predetermined threshold value as content to be recommended for the user.

2. The content processing apparatus according to claim 1, further comprising viewing determining means for outputting information used to determine whether the user has actually viewed the commercials included in the content.

3. The content processing apparatus according to claim 1, wherein each of the commercial preference information and the program commercial information is generated as a vector in which each of the types of commercials is set as an element and a value obtained by normalizing the number of commercials of a corresponding one of the types in a predetermined format is used as a value of the element.

4. A content processing method comprising the steps of:
generating commercial preference information by associating each of types of commercials included in content viewed by a user with the number of times commercials of a corresponding one of the types have been viewed by the user in a predetermined period;
generating program commercial information of each of a plurality of pieces of recorded content by associating each of types of commercials inserted in each of the plurality of pieces of recorded content with the number of commercials of a corresponding one of the types, and computing a similarity between the program commercial information and the commercial preference information; and
specifying content corresponding to the program commercial information having the computed similarity equal to or larger than a predetermined threshold value as content to be recommended for the user.

5. A program causing a computer to function as:
commercial specifying means for specifying types of commercials included in content viewed by a user;
commercial preference information generating means for generating commercial preference information by associating each of the types of commercials with the number of times commercials of a corresponding one of the types have been viewed by the user in a predetermined period;
similarity computing means for generating program commercial information of each of a plurality of pieces of recorded content by associating each of types of commercials inserted in each of the plurality of pieces of recorded content with the number of commercials of a corresponding one of the types, and computing a similarity between the program commercial information and the commercial preference information; and
recommendation specifying means for specifying content corresponding to the program commercial information having the computed similarity equal to or larger than a predetermined threshold value as content to be recommended for the user.

6. A content processing apparatus comprising:
commercial specifying means for specifying types of commercials included in content viewed by a user;
commercial preference information generating means for generating commercial preference information by associating each of the types of commercials with the number of times commercials of a corresponding one of the types have been viewed by the user in a predetermined period;
similarity computing means for computing a similarity between the commercial preference information and viewing characteristic information provided in advance; and
recommendation specifying means for specifying information about a product corresponding to the viewing characteristic information having the computed similarity equal to or larger than a predetermined threshold value as information about a product to be recommended for the user.

7. The content processing apparatus according to claim 6, further comprising viewing determining means for outputting information used to determine whether the user has actually viewed the commercials included in the content.

8. The content processing apparatus according to claim 6,
wherein the commercial preference information is generated as a vector in which each of the types of commercials is set as an element and a value obtained by normalizing the number of commercials of a corresponding one of the types in a predetermined format is used as a value of the element, and
wherein the viewing characteristic information is generated as a vector including the same elements as those included in a vector serving as the commercial preference information.

9. The content processing apparatus according to claim 8, further comprising storing means for associating the information about a product with the viewing characteristic information and storing them, and
wherein the viewing characteristic information supplied from a provider of the product is associated with the product and is stored.

10. A content processing method comprising the steps of:
generating commercial preference information by associating each of types of commercials included in content viewed by a user with the number of times commercials of a corresponding one of the types have been viewed by the user in a predetermined period;
computing a similarity between the commercial preference information and viewing characteristic information provided in advance; and
specifying information about a product corresponding to the viewing characteristic information having the computed similarity equal to or larger than a predetermined threshold value as information about a product to be recommended for the user.

11. A program causing a computer to function as:
commercial specifying means for specifying types of commercials included in content viewed by a user;
commercial preference information generating means for generating commercial preference information by associating each of the types of commercials with the number of times commercials of a corresponding one of the types have been viewed by the user in a predetermined period;
similarity computing means for computing a similarity between the commercial preference information and viewing characteristic information provided in advance; and
recommendation specifying means for specifying information about a product corresponding to the viewing characteristic information having the computed similarity equal to or larger than a predetermined threshold value as information about a product to be recommended for the user.

12. A recording medium recording the program according to claim 5 or 11.

13. A content processing apparatus comprising:
a commercial specification unit configured to specify types of commercials included in content viewed by a user;
a commercial preference information generation unit configured to generate commercial preference information by associating each of the types of commercials with the number of times commercials of a corresponding one of the types have been viewed by the user in a predetermined period;
a similarity computation unit configured to generate program commercial information of each of a plurality of pieces of recorded content by associating each of types of commercials inserted in each of the plurality of pieces of recorded content with the number of commercials of a corresponding one of the types, and compute a similarity between the program commercial information and the commercial preference information; and
a recommendation specification unit configured to specify content corresponding to the program commercial information having the computed similarity equal to or larger than a predetermined threshold value as content to be recommended for the user.

14. A content processing apparatus comprising:
a commercial specification unit configured to specify types of commercials included in content viewed by a user;
a commercial preference information generation unit configured to generate commercial preference information by associating each of the types of commercials with the number of times commercials of a corresponding one of the types have been viewed by the user in a predetermined period;
a similarity computation unit configured to compute a similarity between the commercial preference information and viewing characteristic information provided in advance; and
a recommendation specification unit configured to specify information about a product corresponding to the viewing characteristic information having the computed similarity equal to or larger than a predetermined threshold value as information about-a product to be recommended for the user.
